(19) United States
(12) Patent Application Publication
(10) Pub. No.: US 2025/0021726 A1
(43) Pub. Date: Jan. 16, 2025

(54) System and Method for Artificial Intelligence Driven Fab-Technology Co-Optimization for Generation of Accurate Digital Twin Models for Simulation in Manufacturing and Design

(71) Applicant: SILVACO, INC., Santa Clara, CA (US)

(72) Inventors: Eric GUICHARD, Morgan Hill, CA (US); Babak TAHERI, Phoenix, AZ (US)

(73) Assignee: SILVACO, INC., Santa Clara, CA (US)

(21) Appl. No.: 18/770,431

(22) Filed: Jul. 11, 2024

Related U.S. Application Data
(60) Provisional application No. 63/526,135, filed on Jul. 11, 2023.

(51) Int. Cl. G06F 30/27; G06F 119/18

(52) U.S. Cl. CPC G06F 30/27; G06F 2119/18

(57) ABSTRACT

A physics/chemistry-based artificial intelligence driven modeling tool and method of using the same are provided for optimizing fabrication processes for microelectronic devices. Generally the method begins with assembling a training dataset including features of a target device and performance parameters of the process flow from test machine and/or simulation results. The features of the device are narrowed to a number of input features, and the device digitally modeled using a neural network and AI algorithm, based on the input features and performance parameters. The model is analyzed to find an optimal condition for at least one of the input features. A second number of input features for the device are selected based on the optimal condition(s) are found and the modeling and optimizing are repeated using a design of experiment (DoE) advanced algorithm until a digital twin model of the target device is generated.

### CROSS-REFERENCE TO RELATED APPLICATIONS

This application claims the benefit of priority under 35 U.S.C. 119 (e) to U.S. Provisional Patent Application Ser. No. 63/526,135, filed Jul. 11, 2023.

### TECHNICAL FIELD

The present disclosure relates generally to integrated circuit design, photonics, integrated circuits, and more particularly to an improved approach for designing, testing, and manufacturing integrated circuits both in photonics and electronics.

### BACKGROUND

The latest generations of semiconductor and photonics integrated circuits (ICs) typically include a large number of elements or components connected in three dimensions by wires, waveguides and local interconnects and vias fabricated by forming and patterning different layers of semiconducting, conducting and dielectric materials on semiconductor wafer or wafer. Typically, semiconductor fabrication requires a high degree of automation and integration of complex, specialized equipment in ultra-clean fabrication facilities or ‘fabs.’ As the industry scales to device architectures with nanometer nodes and below, better process control and integration are needed to provide acceptable yields of working devices with desired performance. This control is made more difficult when it is necessary or desired to transfer an established semiconductor process flow for fabricating a device to a different fab or to different individual pieces of equipment in the same fab.

Currently in order to optimize a process flow and foundry yield, process and fab engineers rely on testing of physical wafer by setting up Design-of-Experiments (DoE), and performing numerous trial and error processes with wafer fabrication to optimize process parameters and reach desired goals. However, this approach often leads to multiple costly iterations since wafer fabrication is both expensive and time-consuming. Typically, it can take weeks to months of experimentation depending on what process parameter has fallen off or capability or recipe is lost.

In the manufacturing industry, one way to report and evaluate the process capability and process performance is measuring and monitoring statistical process capability indices, such as Cp and Cpk. Cp estimates what a process is capable of producing if the process mean is centered between upper and lower specification limits, and the process output is approximately normally distributed. Cpk estimates what the process is capable of producing, if the process mean is not centered between the specification limits, again, assuming an approximately normally distributed process output. Cpk and Cp are used in statistical analysis to assess the ability of a process to produce products that meet specifications. indices are monitored, and process parameters are adjusted to achieve the desired levels of Cp and Cpk.

Accordingly, there is a need for better tools and methods to optimize a semiconductor process flow to improve device yield and performance. It is further desirable that the tool and method provide greater productivity through reduction in time required for flow optimization, and reduced material and labor costs.

### SUMMARY

The objective of the invention is to provide a physics and/or chemistry-based artificial intelligence driven modeling tools and methods for optimizing fabrication processes for microelectronic devices. By microelectronic and photonic devices it is meant semiconductor/photonics devices and integrated circuits (ICs), and microelectromechanical systems (MEMS).

Generally the method begins with assembling a training dataset for machine learning including features of a target device and performance parameters of the process flow from a test machine and/or simulation results. The simulation results are generated using a physics and chemistry based numerical algorithm (Technology Computer Aided Design (TCAD)) with digital twin model accuracy, minimizing time and cost. The number of input features of the device are narrowed down, models, based on the input features and performance parameters is created using a machine learning algorithms. The model is analyzed to find an optimal condition for at least one of the input features. A second number of input features for the device are selected based on the optimal condition(s) are found and the modeling and optimizing are repeated using an advanced design of experiment (DoE) algorithm until a digital twin of the target device is generated.

By digital twin model it is meant a virtual representation of a target device or IC designed to accurately reflect properties of a physical embodiment of the device, and in a data format by which it can be read and understood by simulation tools, and hence enables designers to modify and re-simulate an existing design for the target device for further optimization, and/or to explore design of a next generation of target device or products through the use of realistic, manufacturable digital twin model(s).

In another aspect the invention of the present disclosure is further directed to an artificial intelligence (AI) driven modeling tool for optimizing a process flow to fabricate a target device. In one embodiment, the tool includes: a data visualization module, providing to Engineers a first hand of the data trend, helping them to produce a training dataset including features of the target device and performance parameters of the process flow; a wafer map analysis module operable to execute a top/center/bottom/left/right and ring pattern analysis of a wafer on which the target device is to be fabricated with analysis of variance (ANOVA) statistical method; a regression module using a neural network engine operable to digitally model the target device based on the number of input features and performance parameters; an optimization module operable to find an optimal condition for at least one of the number of input features for the target device from the digitally modeled target device; and a design of experiment (DoE) module operable to execute advanced DoE iterative search algorithms to produce more complete digital models based on the optimal condition(s) until a digital twin model of the target device is generated.

Finally, in yet another aspect the invention is further directed to method for optimizing manufacture of a target device, the method comprising using an artificial intelligence (AI) Driven program executed on a computer, generating a digital twin model simulating the target device based on a manufacturing capability of a specified set of wafer equipment in a manufacturing facility. The digital twin model is generated in a data format that can be read and understood by simulation tools, and made available to designers for manufacturing or modifying and re-simulating the target device. Generally, generating the digital twin model using the AI-Driven program, includes: executing an initial design of experiment (DoE) for the target device using an advanced DoE module and a training dataset assembled from test machine and simulation results, the training dataset including a number of features of the target device and performance parameters of the wafer equipment; simulating the target device using technology computer-aided design (TCAD) software; obtaining data on wafer equipment that will be used to manufacture the target device; analyzing and visualizing the simulated target device and data on the wafer equipment to digitally model the target device; identifying an optimal condition for at least one parameter used to fabricate the target device; and repeatedly digitally modeling the target device using the optimal condition found for the target device to generate a digital twin model of the target device.

### BRIEF DESCRIPTION OF THE DRAWINGS

Embodiments of the present invention will be understood more fully from the detailed description that follows and from the accompanying drawings and the appended claims provided below, where:

FIG. 1 is a block diagram illustrating program modules of an artificial-intelligence-driven fab-technology co-optimization (AI-Driven FTCO™) program for generating an accurate digital twin model in order to optimize fabrication of a target device according to an embodiment of the present disclosure;

FIG. 2 is a flow chart illustrating an AI-Driven FTCO™ process or method for generating a digital twin model of a target;

FIG. 3A is a simplified block diagram illustrating a process flow using an AI-Driven FTCO™ program for optimizing fabrication of a target device using silicon carbide (SiC) technology according to embodiments of the present disclosure;

FIG. 3B is a simplified block diagram illustrating a process flow using an AI-Driven FTCO™ program for optimizing fabrication of a target device using nanowire technology; and

FIG. 3C is a simplified block diagram illustrating a process flow using an AI-Driven FTCO™ program for optimizing fabrication of a target device using technology for fabricating memory devices according to embodiments of the present disclosure.

### DETAILED DESCRIPTION

A physics/chemistry-based artificial intelligence (AI) driven modeling tool and method of using the same are provided for optimizing fabrication processes used for fabricating semiconductor devices, integrated circuits (ICs), photonics and microelectromechanical systems (MEMS).

In the following description, for purposes of explanation, numerous specific details are set forth in order to provide a thorough understanding of the present invention. It will be evident, however, to one skilled in the art that the present invention may be practiced without these specific details. In other instances, well-known structures, and techniques are not shown in detail or are shown in block diagram form in order to avoid unnecessarily obscuring an understanding of this description.

Reference in the description to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment. The term to couple as used herein may include both to directly electrically connect two or more components or elements and to indirectly connect through one or more intervening components.

In the past, process and fab engineers used a trial and error process to create and set up design of experiments (DoEs), realized in silicon to optimize their processes. The resulting wafers are then analyzed to understand whether the process is meeting the desired targets.

At a high level, the method of the present invention uses artificial intelligence (AI) and machine learning (ML) to generate much more accurate digital models, i.e., digital twin models, taking into account the physics and chemistry of the processes, which can then be tested and analyzed using DoE to reduce both fab tuning cycle times and costs associated with having to fabricate multiple actual devices. By digital twin model it is meant a virtual representation of a target device or IC designed to accurately reflect properties of a physical embodiment of the device, and in a data format by which it can be read and understood by simulation tools, and hence enables designers to modify and re-simulate an existing design for the target device for further optimization, and/or to explore design of a next generation of target device or products through the use of realistic, manufacturable digital twin model(s). Digital twin models achieve this reduction in fab tuning cycle times and costs by being able to provide accurate models much faster than can be obtained using current methods, which require actual fabrication of a large number of prototypes or test devices.

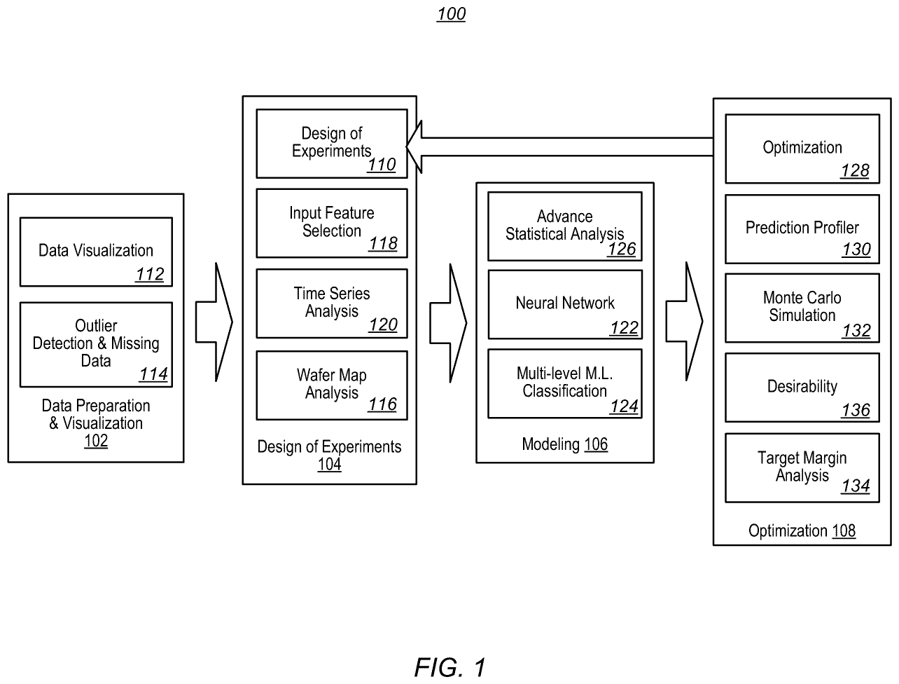

FIG. 1 is a block diagram illustrating program modules of an artificial intelligence (AI) driven modeling tool for optimizing a process flow for fabricating an integrated circuit (IC) or target device or according to embodiments of the present disclosure. Generally, the AI-Driven modeling tool is implemented as an AI-driven FTCO™ program code stored in non-transitory computer readable memory of a general purpose computer, work station or other computer system, capable of being executed by the computer.

Referring to FIG. 1, the program 100 includes a data preparation and visualization block (visualization block 102), a design of experiments (DoE) block 104, a modeling block 106 and an optimization block 108. Generally, the visualization block 102 is configured or operable to assemble a training dataset including features of the target device and performance parameters of the process flow from a number of physical test devices and/or simulation results. The DoE block 104 is configured or operable to receive the training dataset from the visualization block 102, and to narrow a number of features of the target device selected for optimization by or in the process flow. The modeling block 106 is configured or operable to receive the training dataset from the visualization block 102, and to create a digital model of the target device. The optimization block 108 is configured or operable to receive the digitally modeled target device from the modeling block 106 and to find an optimal condition for at least one of the number of input features for the target device from the digitally modeled target device, and to provide resultant optimal condition(s) to a design of experiment (DoE) module 110 in the DoE block 104 operable to execute advanced DoE iterative search algorithms to produce more complete digital models based on the optimal condition(s) until a digital twin model of the target device is generated.

Generally, as shown in FIG. 1 the visualization block 102 includes a number of sub-routines or modules including a data visualization module 112 and an advanced outlier detection and missing data treatment module (missing data module 114). The data visualization module 112 includes is operable to provide a number of plots, graphs and maps that can be used by a user or designer for visualizing multivariate data. Data Visualization is a critical piece of data analysis and provides a designer a first-hand insight of a data trend to assemble a training dataset including features of the target device and performance parameters of the process flow. The features visualized can include electrical properties as well as physical dimensions of the target device. The performance parameters of the process flow visualized can include deposition or growth rates of material formed or deposited on a wafer, etch rates, implantation or doping rates and depth, process temperatures and pressures, and quality or properties of materials formed or patterned. The data can be visualized or graphically presented using three dimensional (3D) scattering plots, 3D surface plots, box plots, parallel coordinates plots, distribution plot or graph and/or color maps. Such plots, graphs and maps can be generated, for example, using MATLAB® software, commercially available from The Math Works, Inc. of Natick, Mass.

The missing data module 114 is operable to automatically detect and remove outliers, and to impute values for missing data in the training dataset. Outliers can distort the results of data analysis, making it difficult to draw accurate conclusions. Thus, it is desirable to remove any outliers from the data as part of data pre-processing. This can be accomplished, for example, using an outlier detection tool powered by an Isolation Forest (iForest) machine learning algorithm where the tool detects outliers automatically. iForest is a machine learning algorithm for anomaly detection. One such outlier detection tool is commercially available from Victory Analytics of Bristol, in the United Kingdom.

Additionally, at times the dataset contains incomplete data entries or missing data, and it is desirable that the missing data module 114 includes program code to fill-in or estimate missing data using statistical methods and mean or median values, or through multiple imputation by chained equations. In some embodiments, the imputation of missing data can be implemented or accomplished by a feature of the outlier detection tool.

The DoE block 104, in addition to the DoE module 110, includes a wafer map analysis module 116, an input feature selection module 118, and a time series analysis module 120.

Generally, the wafer map analysis module 116 includes program code for implementing maps and tools that can be used to perform a wafer map analysis of a number of wafers such as those on which the target device is to be fabricated. Data resulting from the wafer map analysis is used for advanced design of experiment (DoE) in the DoE module 110. Wafer map analysis enable the detecting and classifying or visualizing of defects in patterns or results of processing over wafer location. These analysis and include Top/Center/Bottom/Left/Right and ring patterns produced using an Analysis of variance (ANOVA) statistical method. ANOVA is a collection of statistical models and their associated estimation procedures (such as the “variation” among and between groups) used to analyze the differences among means.

The input feature selection module 118 includes program code for two different machine learning techniques that can be used for input feature selection. In dealing with large number of features, it is desirable to reduce the number of input parameters in order to improve the performance of the AI-Driven FTCO™ technique. Generally, two feature selection techniques are implemented in the feature selection module 118, one using an advanced statistics method (stepwise forward regression), and the other using a machine learning algorithm such as Random Forest. Stepwise regression is a method of fitting regression models in which the choice of predictive variables is carried out by an automatic procedure. Stepwise forward regression, involves starting with no variables in the model, testing the addition of each variable using a chosen model fit criterion, adding the variable (if any) whose inclusion gives the most statistically significant improvement of the fit, and repeating this process until further improvement to the model is not statistically significant. Random Forest is a commonly-used machine learning algorithm, which combines the output of multiple decision trees to reach a single result. Both methods calculate the importance of each feature, ranked according to their importance. Finally, the user can select the most important or core features to build the model for better accuracy.

The time series analysis module 120 includes program code for implementing three time series models for future forecasting of integrated circuit (IC) parameters, and which can be used for input feature selection. Time series data analysis is used to identify patterns and trends in the time series data, and to make predictions about future values. The time series analysis module 120 can use Auto Regressive (AR) and Moving Average (MA) models or techniques to predict future values. Alternatively, the time series analysis module 120 can use an Auto Regressive Integrated Moving Average (ARIMA) model, which is a generalization of the ARMA model. Preferably, the time series analysis module 120 is uses a Seasonal Auto Regressive Integrated Moving Average (SARIMA) model, which is capable of extracting a seasonal component from the time series dataset, where the seasonal component is a systematic pattern that repeats over a given period of time.

The design of experiment (DoE) module 110 includes program code for implementing an advanced DoE and iterative search algorithms. Additionally, the DoE module 110 is capable of outputting to a user a number of DoE plots, including a Pareto plot and a Fraction of Design Space (FDS) plot. A Pareto plot contains both bars and a line graph, where individual values generated by the DoE are represented in descending order by bars, and a cumulative total of the values is represented by the line. A FDS plot illustrates or provides detailed information for a specified value generated by the DoE as a single, scaled curve for a specified design region. For example, a standard error or deviation of values generated by the DoE may be graphed in an FDS plot as a function of the fraction of design space.

Preferably, the DoE module 110 is capable of conducting augmented DoE as well as constrained DoE. Computer generated DoE based on a D-optimal design is superior to traditional DoE methods. D-optimal designs are model-specific generated by a software tool using an iterative search algorithm that seeks to minimize the covariance of the parameter estimates for a specified model. One such Design of Experiments tool is commercially available from Victory Analytics of Bristol, in the United Kingdom, which is capable of conducting augmented DoE as well as constrained DoE.

The modeling block 106 includes a neural network module 122, a multi-level machine learning (ML) classification module 124, and an advanced statistical analysis module 126.

The neural network module 122 includes program code for creating a digital model of the target device using data from the advanced statistical analysis module 126 and a neural network (NN) engine. The neural network module 122 uses a core regression model powered by a Neural Network algorithm. The NN engine is flexible enough to enable a user design NN parameters in accordance with selected conditions. The NN control parameters include number of neurons, number of hidden layers, activation function, where hidden layers include a number of layers or decision layer between inputs to and outputs from the neural network (NN). Preferably, the NN algorithm is capable of modeling non-linear data behaviors without complications.

The multi-level machine learning classification module 124 includes program code for implementing a multi-level classification of data using a Random Forest Machine learning algorithm for creating a digital model of the target device to be fabricated. The Random Forest Machine learning algorithm provides plots, such as color plots, for identifying multiple groups to enable the user to obtain a good insight of the data.

The advanced statistical analysis module 126 includes program code for performing basic statistical analysis of the digital model in real time, and providing data resulting from the analysis to the neural network module 122.

The optimization block 108 includes an optimization module 128, a prediction profiler module 130, a Monte Carlo simulation module 132, a target margin analysis module 134, and a desirability module 136.

The optimization module 128 includes program code for optimizing input conditions with or without constraint to meet a target parameter for the target device to be fabricated. Once the model is established or created by the modeling block 106 using trained dataset data from the visualization block 102, the user can find the input conditions required to meet a particular target value for fabricating the target device. Preferably, the optimization module 128 includes and uses various, multiple different optimization algorithms. More preferably, the optimization module 128 is able to limit the optimization criteria with constraint(s) on target values, and to enable the user to locate an optimal point on, for example, a 3D surface plot of the design space. One such tool for implementing the optimization module 128 is commercially available from Victory Analytics of Bristol, in the United Kingdom.

The prediction profiler module 130 includes program code for generating plots of real time simulation of output behaviors of the digitally modeled device with respect to input variables for optimizing the target device to be fabricated. Once the machine learning model is established in the modeling block 106, the user simulates the target behavior with respect to various input values. This feature enables user to predict model behavior such as identifying input with high influence.

The Monte Carlo simulation module 132 includes program code for generating plots of target output behavior based on input level and distribution, which is particularly useful for analysis of the process capability (Cp) and process capability indices (Cpk). Instead of evaluating a single value of input parameter, Monte Carlo simulation is designed to reflect the variation component of the input parameter. Not only can the user obtain the target value, but also can obtain a distribution of the key or selected parameters of the digitally modeled target device.

The target margin analysis module 134 includes program code for analyzing proximity of key or selected parameters of the digitally modeled target device to user specified high, low and median values to obtain target margins for the digitally modeled device. The desirability module 136 includes program code for collecting time-aggregated parameters of the digitally modeled target device at a wafer scale, and indicating when the optimized process has satisfied a desired process capability (Cp) and process capability indices (Cpk).

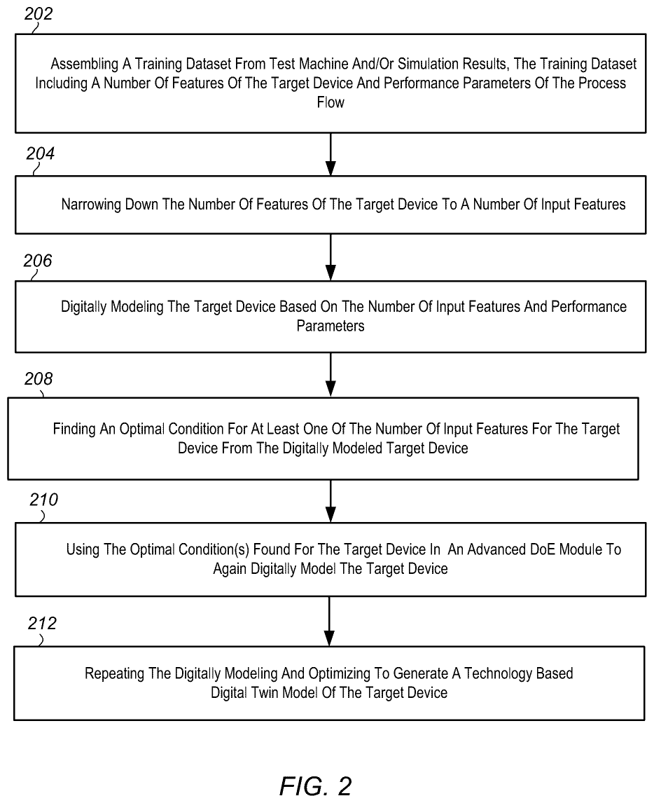

FIG. 2 is a flow chart illustrating an AI-Driven FTCO™ process or method for generating a digital twin model of a target device for optimizing a process flow for fabricating the target device. Referring to FIG. 2 the method begins with assembling a training dataset from a test machine and/or simulation results, the training dataset including a number of features of the target device and performance parameters of the process flow (step 202). By test machine it is meant a machine or tool operable to measure properties of an actual target device or process parameters used in wafer equipment to fabricate the target device. As described above with respect to FIG. 1, assembling a training dataset includes data visualization using a data visualization module operable to graphically visualize data using one or more of a three dimensional (3D) scattering plot, a 3D surface plot, a box plot, a parallel coordinates plot, a distribution plot and a color map. Generally, assembling a training dataset further comprises detecting outliers and missing data using an outlier detection and missing data module operable to automatically detect outliers with an Isolation Forest (iForest) machine learning algorithm, and to fill in missing data with mean and/or median data values, and through multiple imputation by chained equations.

Next, the number of features of the target device is narrowed to a number of input features (step 204). As described above with respect to FIG. 1, narrowing down the features of the target device includes a user selecting the number of input features using a wafer map analysis module operable to execute a top/center/bottom/left/right and ring pattern analysis of a wafer on which the target device is to be fabricated with analysis variance (ANOVA) statistical method. Generally, the narrowing down the features of the target device further includes selecting the number of input features using an input feature selection module operable to execute at least one of two different machine learning techniques including a stepwise forward regression and a Random Forest algorithm, and selecting the number of input features using a time series analysis module operable to identify patterns and trends in time series data, and to make predictions about future values using Auto Regressive (AR) and Moving Average (MA) modeling.

The target device is then digitally modeled based on the number of input features and performance parameters (step 206). As described above with respect to FIG. 1, digitally modeling the target device includes digitally modeling the target device using a neural network module including a neural network (NN) engine powered by a NN algorithm. Generally, digitally modeling the target device further includes using a multi-level machine learning (ML) classification module including a Forest Machine learning algorithm to create the digital model.

An optimal condition is then found for at least one of the number of input features for the target device from the digitally modeled target device (step 208). As described above with respect to FIG. 1, finding an optimal condition for at least one of the number of input features includes using an optimization module operable to provide a user a 3D surface plot of a design space, and to execute various optimization algorithms to limit optimization criteria with constraints on targets values selected by the user. Generally, finding an optimal condition for at least one of the number of input features further includes using a prediction profiler module operable to generate plots of real time simulation of output behaviors of the target device with respect to the input features. In some embodiments, finding an optimal condition for at least one of the number of input features further includes using a Monte Carlo simulation module operable to generate plots of target output behavior based on input level and distribution for analysis of Cp and Cpk process capability indices.

Finally, the optimal condition(s) found for the target device are used in an advanced design of experiment (DoE) module to again digitally model the target device (step 210), and the digitally modeling and optimizing steps repeated to generate a digital twin model of the target device (step 212). Generally, repeating the digitally modeling and optimizing to generate a digital twin model of the target device includes using the advanced DoE module and iterative search algorithms to produce more complete digital models until the digital twin model of the target device is generated. At this point a digital twin model of the target device is realized, and the inputs, including both desired properties for target device input by a designer and process parameters at which to operate wafer equipment or tools to fabricate an actual target device, have been found.

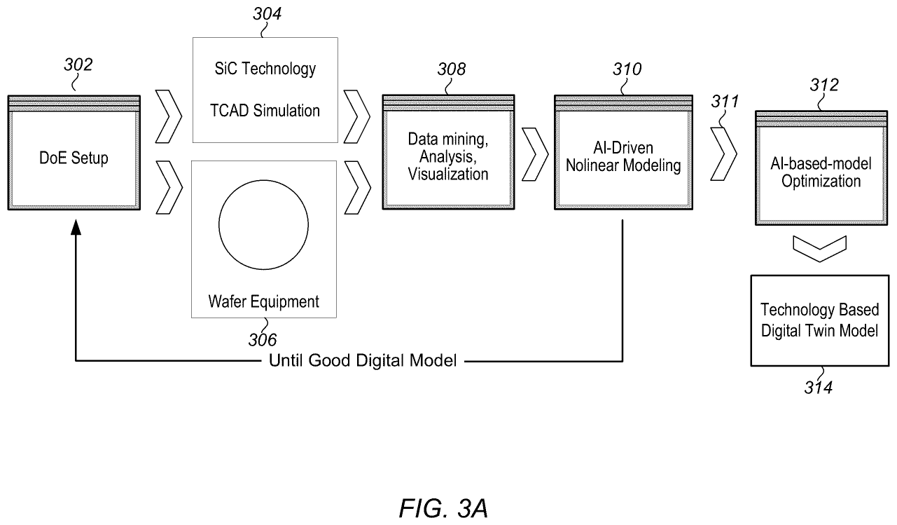

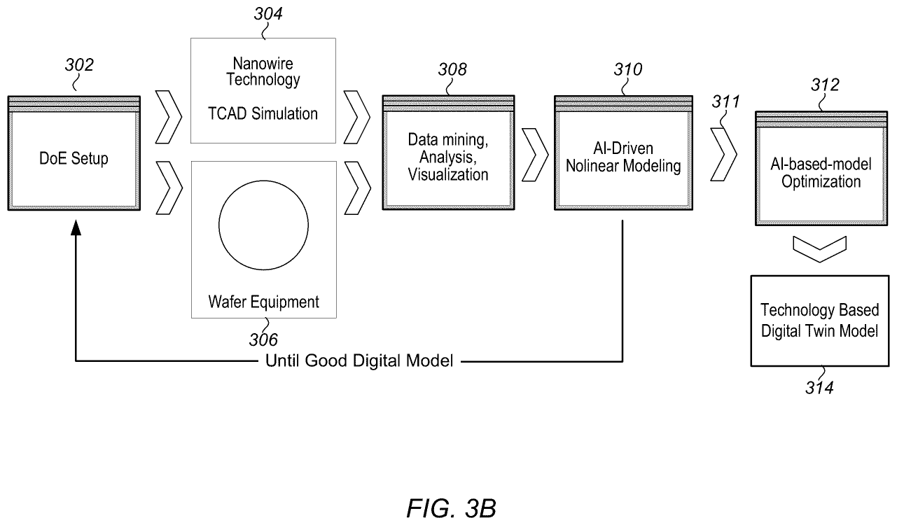

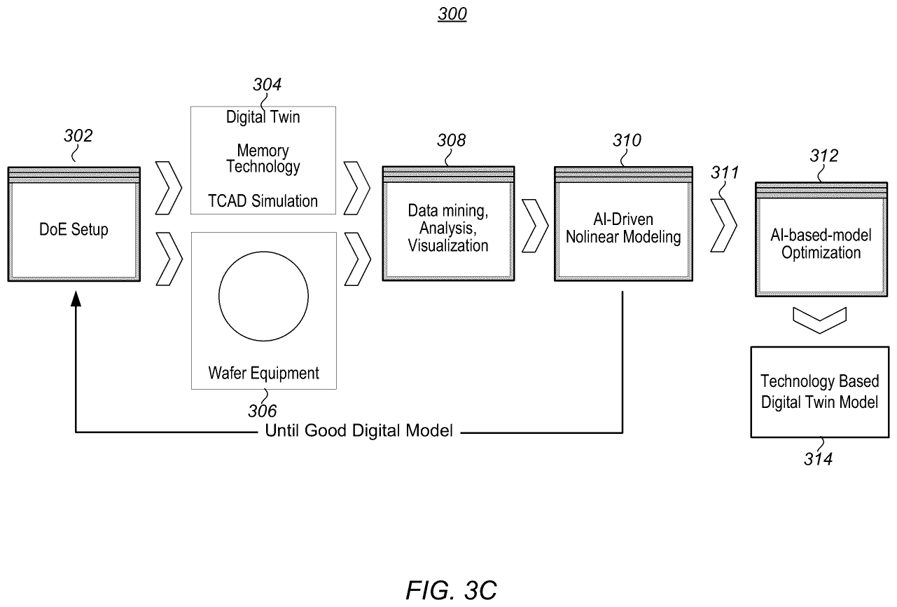

FIG. 3A is a simplified block diagram illustrating a process flow 300 using an AI-Driven FTCO™ program for optimizing fabrication of a target device using silicon carbide (SiC) technology according to embodiments of the present disclosure. Briefly, the process flow using the AI-Driven FTCO™ program combines a physics based model with machine learning (ML) analytics to provide a strong digital twin model of the target device to optimize parameters of the fabrication process.

Referring to FIG. 3A, the process begins with a design of experiment (DoE) setup 302. An initial DoE setup 302 can utilize a training dataset including test machine and/or simulation data. The target device is then simulated using technology computer-aided design (TCAD) software 304. The simulated target device and data on tool(s) or wafer equipment 306 that will be used fabricate the target device is then analyzed using the data mining, analysis and visualization software 308, and the device digitally modeled using the AI-Driven nonlinear modeling software 310 of the AI-Driven FTCO™ program described above. The results of this analysis and digital modeling is used for a subsequent DoE setup 302, and the process repeated until a good digital model of the target device, represented here by arrow 311, is obtained. The good digital model of the target device is then optimized using AI-based-model optimization 312 until a technology based digital twin model 314 using the desired technology, shown here as SiC technology, is obtained. The tool(s) or wafer equipment can then be operated at process parameters found in obtaining the technology based digital twin model 314 to fabricate an actual, physical target device.

Process parameters found through this process flow can include temperature, pressure, chemistry, time and power levels at which wafer equipment is operated to fabricate a target device having the desired performance. It is noted that the data on the wafer equipment 306 can be derived from general information on a piece of wafer equipment provided by the equipment manufacturer, or, more preferably on a particular piece of wafer equipment operated by a user of the AI-Driven FTCO™ program, and derived from previous experiments or devices manufactured using the equipment.

It is noted that use of AI-Driven FTCO™ results in fewer wafer runs, a lower number of physical experiments, a faster time to achieve a desired yield and fewer errors due to automation, thereby lowering the cost of manufacturing and speeding up a time to market (TTM) of the target device.

Similarly, FIG. 3B is a simplified block diagram illustrating a process flow using an AI-Driven FTCO™ program 100 for optimizing fabrication of a target device using nanowire technology according to embodiments of the present disclosure. Briefly, after initial DoE setup 302 the target device is then simulated using TCAD software 304, and the simulated target device and data on tool(s) or wafer equipment 306 is then analyzed using the data mining, analysis and visualization software 308 and digitally modeled using the AI-Driven nonlinear modeling software 310 of the AI-Driven FTCO™ program. The results of this analysis and digital modeling is used for a subsequent DoE setup 302, and the process repeated until a good digital model of the target device, represented here by arrow 311, is obtained. The good digital model of the target device is then optimized using AI-based-model optimization 312 until a technology based digital twin model 314 using the desired technology, shown here as nanowire technology, is obtained. The tool(s) or wafer equipment can then be operated at process parameters found in obtaining the technology based digital twin model 314 to fabricate an actual, physical target device.

FIG. 3C is a simplified block diagram illustrating a process flow using an AI-Driven FTCO™ program 100 for optimizing fabrication of a target device using memory technology for fabricating memory devices, such as charge trapping or floating gate devices, according to embodiments of the present disclosure. Briefly, after initial DoE setup 302 the target device is then simulated using TCAD software 304, and the simulated target device and data on tool(s) or wafer equipment 306 is then analyzed using the data mining, analysis and visualization software 308 and digitally modeled using the AI-Driven nonlinear modeling software 310 of the AI-Driven FTCO™ program described above. The results of this analysis and digital modeling is used for a subsequent DoE setup 302, and the process repeated until a good digital model of the target device, represented here by arrow 311, is obtained. The good digital model of the target device is then optimized using AI-based-model optimization 312 until a technology based digital twin model 314 using the desired technology, shown here as memory technology, is obtained. The tool(s) or wafer equipment can then be operated at process parameters found in obtaining the technology based digital twin model 314 to fabricate an actual, physical target device.

Thus, embodiments of an artificial intelligence (AI) driven modeling tool and method of operating the same for optimizing a process flow to fabricate a target device have been described. Although the present disclosure has been described with reference to specific exemplary embodiments, it will be evident that various modifications and changes may be made to these embodiments without departing from the broader spirit and scope of the disclosure. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of one or more embodiments of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

Reference in the description to one embodiment or an embodiment means that a particular feature, structure, or characteristic described in connection with the embodiment is included in at least one embodiment of the circuit or method. The appearances of the phrase one embodiment in various places in the specification do not necessarily all refer to the same embodiment.

What is claimed is:

1. A method for optimizing a process flow for fabricating a target device, the method comprising:
assembling a training dataset from test machine and simulation results, the training dataset including a number of features of the target device and performance parameters of the process flow;
narrowing down the number of features of the target device to a number of input features;
digitally modeling the target device based on the number of input features and performance parameters;
finding an optimal condition for at least one of the number of input features for the target device from the digitally modeled target device;
using the optimal condition(s) found for the target device and an advanced design of experiment (DoE) module to again digitally model the target device; and
repeating the digitally modeling and optimizing to generate a digital twin model of the target device.

2. The method of claim 1, wherein assembling a training dataset comprises data visualization using a data visualization module operable to graphically visualize data using one or more of a three dimensional (3D) scattering plot, a 3D surface plot, a box plot, a parallel coordinates plot, a distribution plot and a color map.

3. The method of claim 2, wherein assembling a training dataset further detecting outliers and missing data using an outlier detection and missing data module operable to automatically detect outlier with an Isolation Forest (iForest) machine learning algorithm, and to fill in missing data with mean or median data values, and through multiple imputation by chained equations.

4. The method of claim 1, wherein narrowing down the features of the target device comprises a user selecting the number of input features using a wafer map analysis module operable to execute a top/center/bottom/left/right and ring pattern analysis of a wafer on which the target device is to be fabricated with analysis of variance (ANOVA) statistical method.

5. The method of claim 4, wherein narrowing down the features of the target device further comprises selecting the number of input features using an input feature selection module operable to execute at least one of two different machine learning techniques including a stepwise forward regression and a Random Forest algorithm.

6. The method of claim 5, wherein narrowing down the features of the target device further comprises selecting the number of input features using a time series analysis module operable to identify patterns and trends in time series data, and to make predictions about future values using Auto Regressive (AR) and Moving Average (MA) modeling.

7. The method of claim 1, wherein digitally modeling the target device comprises digitally modeling the target device using a neural network module including a neural network (NN) engine powered by a NN algorithm.

8. The method of claim 7, wherein digitally modeling the target device further comprises using a multi-level machine learning classification module including a Forest Machine learning algorithm for creating the digital model.

9. The method of claim 1, wherein finding an optimal condition for at least one of the number of input features comprises using an optimization module operable to provide a user a 3D surface plot of a design space, and to execute various optimization algorithms to limit optimization criteria with constraint on targets values selected by the user.

10. The method of claim 9, wherein finding an optimal condition for at least one of the number of input features further comprises using a prediction profiler module operable to generate plots of real time simulation of output behaviors of the target device with respect to the input features.

11. The method of claim 10, wherein finding an optimal condition for at least one of the number of input features further comprises using a Monte Carlo simulation module operable to generate plots of target output behavior based on input level and distribution for analysis of Cp and Cpk process capability indices.

12. The method of claim 1, wherein repeating the digitally modeling and optimizing to generate a digital twin model of the target device comprises using a design of experiment (DoE) module operable to execute advanced DoE and iterative search algorithms to produce more complete digital models until the digital twin model of the target device is generated.

13. An artificial intelligence (AI) driven modeling tool for optimizing a process flow to fabricate a target device, the AI-Driven modeling tool comprising computer readable program embodied in a computer readable storage medium on a computer, the computer readable program comprising program code to:
assemble a training dataset from test machine and simulation results, the training dataset including a number of features of the target device and performance parameters of the process flow;
narrow down the number of features of the target device to a number of input features;
digitally model the target device based on the number of input features and performance parameters;
find an optimal condition for at least one of the number of input features for the target device from the digitally modeled target device; and
using the optimal condition(s) found for the target device, repeatedly digitally model and optimize at least one of the number of input features to generate a digital twin model of the target device.

14. The modeling tool of claim 13, wherein the program code to assemble the training dataset comprises a data visualization module operable to graphically visualize data using one or more of a three dimensional (3D) scattering plot, a 3D surface plot, a box plot, a parallel coordinates plot, a distribution plot and a color map.

15. The modeling tool of claim 13, wherein the program code to assemble the training dataset comprises an outlier detection and missing data module operable to automatically detect outlier with an Isolation Forest (iForest) machine learning algorithm, and to fill in missing data with mean or median data values, and through multiple imputation by chained equations.

16. The modeling tool of claim 13, wherein the program code to narrow down the features of the target device comprises program code to enable a user to select the number of input features using a wafer map analysis module operable to execute a top/center/bottom/left/right and ring pattern analysis of a wafer on which the target device is to be fabricated with analysis of variance (ANOVA) statistical method.

17. The modeling tool of claim 16, wherein the program code to narrow down the features of the target device comprises an input feature selection module operable to execute at least one of two different machine learning techniques including a stepwise forward regression and a Random Forest algorithm.

18. The modeling tool of claim 13, wherein the program code to digitally model the target device comprises a neural network module including a neural network (NN) engine powered by a NN algorithm to digitally model the target device.

19. The modeling tool of claim 13, wherein:
the program code to find an optimal condition for at least one of the number of input features comprises an optimization module operable to provide a user a 3D surface plot of a design space, and to execute various optimization algorithms to limit optimization criteria with constraint on targets values selected by the user, wherein optimization module further comprises a prediction profiler module operable to generate plots of real time simulation of output behaviors of the target device with respect to the input features, and a Monte Carlo simulation module operable to generate plots of target output behavior based on input level and distribution for analysis of process capability indices; and
the program code to repeatedly digitally model and optimize at least one of the number of input features comprises a design of experiment (DoE) module operable to execute advanced DoE and iterative search algorithms to produce more complete digital models until the digital twin model of the target device is generated.

20. A method for optimizing manufacture of a target device, the method comprising using an artificial intelligence (AI) Driven program executed on a computer, generating a digital twin model simulating the target device based on a manufacturing capability of a specified set of wafer equipment in a manufacturing facility.

21. The method of claim 20, wherein generating the digital twin model comprises generating a digital twin model in a data format that can be read and understood by simulation tools, and made available to designers for manufacturing or modifying and re-simulating the target device.

22. The method of claim 20, wherein generating the digital twin model using the AI-Driven program, comprises:
executing an initial design of experiment (DoE) for the target device using an advanced DoE module and a training dataset assembled from test machine and simulation results, the training dataset including a number of features of the target device and performance parameters of the wafer equipment;
simulating the target device using technology computer-aided design (TCAD) software;
obtaining data on wafer equipment that will be used to manufacture the target device;
analyzing and visualizing the simulated target device and data on the wafer equipment to digitally model the target device;
identifying an optimal condition for at least one parameter used to fabricate the target device; and
repeatedly digitally modeling the target device using the optimal condition found for the target device to generate a digital twin model of the target device.
